(19) United States
(12) Patent Application Publication
(10) Pub. No.: US 2010/0296823 A1
(43) Pub. Date: Nov. 25, 2010

(54) DUAL ENGINE SYNCHRONIZATION

(76) Inventors: Michael T. Dobbertin, Honeoye, NY (US); Ronald W. Stephens, Lima, NY (US); Thomas K. Sciurba, Webster, NY (US); Donald S. Rimai, Webster, NY (US); Donna P. Suchy, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 12/468,286

(22) Filed: May 19, 2009

(51) Int. Cl. G03G 15/00

(52) U.S. Cl. 399/16

(57) ABSTRACT

A method of synchronizing the timing of a plurality of physically coupled print engines wherein the receiving sheet is inverted between a first and a second print engine including determining a position of one or more timing marks on a first primary imaging member in a first print engine having a first timing, directing a receiving sheet from the first print engine to a second primary imaging member in a second print engine having a second timing, determining an actual arrival time of the receiving sheet relative to a fixed position in the second print engine, and calculating an optimum timing offset using the one or more timing marks on the first primary imaging member, the actual arrival time of the receiving sheet and the distance of the non-printable area to the fixed position in the second engine.

### CROSS REFERENCE TO RELATED APPLICATIONS

This application relates to commonly assigned, copending U.S. application Ser. No. ______ Docket No. 95546DPS), filed ______, entitled: “PRINT ENGINE SPEED COMPENSATION”, U.S. application Ser. No. ______ (Docket No. 95547DPS), filed ______, entitled: “SCALING IMAGE IN A DUAL ENGINE SYSTEM”, and U.S. patent application Ser. No. (Docket No. 95652DPS), filed ______, entitled: “SCALING IMAGES USING MATCHED COMPONENTS IN A DUAL ENGINE SYSTEM.”

### FIELD OF THE INVENTION

This invention relates to a process of synchronizing a plurality of coupled digital print engines that allows for multiple frame modes.

### BACKGROUND OF THE INVENTION

In typical commercial reproduction apparatus (electrographic copier/duplicators, printers, or the like), a latent image charge pattern is formed on a primary imaging member (PIM) such as a photoreceptor used in an electrophotographic printing apparatus. While the latent image can be formed on a dielectric PIM by depositing charge directly corresponding to the latent image, it is more common to first uniformly charge a photoreceptive PIM member. The latent image is then formed by area-wise exposing the PIM in a manner corresponding to the image to be printed. The latent image is rendered visible by bringing the primary imaging member into close proximity to a development station. A typical development station may include a cylindrical magnetic core and a coaxial nonmagnetic shell. In addition, a sump may be present containing developer which includes marking particles, typically including a colorant such as a pigment, a thermoplastic binder, one or more charge control agents, and flow and transfer aids such as submicrometer particles adhered to the surface of the marking particles. The submicrometer particles typically include silica, titania, various lattices, etc. The developer also typically includes magnetic carrier particles such as ferrite particles that tribocharge the marking particles and transport the marking particles into close proximity to the PIM, thereby allowing the marking particles to be attracted to the electrostatic charge pattern corresponding to the latent image on the PIM, thereby rendering the latent image into a visible image.

The shell of the development station is typically electrically conducting and can be electrically biased so as to establish a desired difference of potential between the shell and the PIM. This, together with the electrical charge on the marking particles, determines the maximum density of the developed print for a given type of marking particle.

The image developed onto the PIM member is then transferred to a suitable receiver such as paper or other substrate. This is generally accomplished by pressing the receiver into contact with the PIM member while applying a potential difference (voltage) to urge the marking particles towards the receiver. Alternatively, the image can be transferred from the primary imaging member to a transfer intermediate member (TIM) and then from the TIM to the receiver.

The image is then fixed to the receiver by fusing, typically accomplished by subjecting the image bearing receiver to a combination of heat and pressure. The PIM and TIM, if used, are cleaned and made ready for the formation of another print.

A printing engine generally is designed to generate a specific number of prints per minute. For example, a printer may be able to generate 150 single-sided pages per minute (ppm) or approximately 75 double-sided pages per minute with an appropriate duplexing technology. Small upgrades in system throughput may be achievable in robust printing systems. However, the doubling of throughput speed is mainly unachievable without a) purchasing a second reproduction apparatus with throughput identical to the first so that the two machines may be run in parallel, or without b) replacing the first reproduction apparatus with a radically redesigned print engine having double the speed. Both options are very expensive and often with regard to option (b), not possible.

Another option for increasing printing engine throughput is to utilize a second print engine in series with a first print engine. For example, U.S. Pat. No. 7,245,856 discloses a tandem print engine assembly which is configured to reduce image registration errors between a first side image formed by a first print engine, and a second side image formed by a second print engine. Each of the '856 print engines has a seamed photoreceptive belt. The seams of the photoreceptive belt in each print engine are synchronized by tracking a phase difference between seam signals from both belts. Synchronization of a slave print engine to a main print engine occurs once per revolution of the belts, as triggered by a belt seam signal, and the speed of the slave photoreceptor and the speed of an imager motor and polygon assembly are updated to match the speed of the master photoreceptor. Unfortunately, such a system tends to be susceptible to increasing registration errors during each successive image frame during the photoreceptor revolution. Furthermore, given the large inertia of the high-speed rotating polygon assembly, it is difficult to make significant adjustments to the speed of the polygon assembly in the relatively short time frame of a single photoreceptor revolution. This can limit the response of the '856 system on a per revolution basis, and make it even more difficult, if not impossible, to adjust on a more frequent basis.

In general, the timing offset of the first and second engines are determined by paper transport time from image transfer in the first engine to the image transfer in the second engine. If the sheet is inverted between the engines, the transport time can be a function of the receiver length. In order to obtain sufficient timing latitude to compensate for varying receiver sheet sizes, one could run the inverter assembly at a very high rate of speed to minimize the effects of receiver size. Alternatively, one can use the maximum size image frame for all receiver sizes. However, this would significantly reduce productivity.

Color images are made by printing separate images corresponding to an image of a specific color. The separate images are then transferred, in register, to the receiver. Alternatively, they can be transferred in register to a TIM and from the TIM to the receiver or they may be transferred separately to a TIM and then transferred and registered on the receiver. For example, a printing engine assembly capable of producing full color images may include at least four separate print engines or modules where each module or engine prints one color corresponding to the subtractive primary color cyan, magenta, yellow, and black. Additional development modules may include marking particles of additional colorants to expand the obtainable color gamut, clear toner, etc., as are known in the art. The quality of images produced on different print engines can be found to be objectionable if produced on different print engines even if the print engines are nominally the same, e.g. the same model produced by the same manufacturer. For example, the images can have slightly different sizes, densities or contrasts. These variations, even if small, can be quite noticeable if the images are compared closely.

In order to maximize productivity, different image frame sizes are utilized for different size receivers. Generally, the frame sizes are defined as preset portions of a primary imaging member in a printer such as equal portions that are from integral divisors of a primary imaging member (PIM), such as a photoreceptor, used in an electrophotographic engine. While this is often done to avoid a splice in a seemed PIM, it may be desirable for other reasons as well. For example, various process control algorithms may require that specific locations of a PIM be used solely for specific marks related to process control.

It is clearly important that sheet timing offset needs to be carefully synchronized between any coupled engines while keeping the ability to change paper sizes and types during print cycles by optimizing the timing offset as described below. This is especially critical when circumstances change such as printing on very different sized papers, such as between 6″ and 11″ paper and different paper types, such as gloss and matte. It is clear that a method is needed to allow comparable prints to be produced on a plurality of engines.

### SUMMARY OF THE INVENTION

This invention pertains to a method to synchronize the image frame timing of a slave print engine to a master in a multiple engine configuration that supports more than one image frame size. method of synchronizing the timing of a plurality of physically coupled print engines wherein the receiving sheet is inverted between a first and a second print engine including determining a position of one or more timing marks on a first primary imaging member in a first print engine having a first timing, directing a receiving sheet from the first print engine to a second primary imaging member in a second print engine having a second timing, determining an actual arrival time of the receiving sheet relative to a fixed position in the second print engine, and calculating an optimum timing offset using the one or more timing marks on the first primary imaging member, the actual arrival time of the receiving sheet and the distance of the non-printable area to the fixed position in the second engine.

### BRIEF DESCRIPTION OF THE DRAWINGS

FIG. 1 schematically illustrates an embodiment of an electrophotographic print engine.

FIG. 2 schematically illustrates an embodiment of a reproduction apparatus having a first print engine.

FIGS. 3A-3C schematically illustrate embodiments of a reproduction apparatus having a first print engine and a tandem second print engine from a productivity module.

FIG. 4 schematically illustrates an embodiment of a reproduction or printing apparatus having embodiments of a first and second print engines.

FIG. 5 schematically depicts a flow chart showing how synchronization offset time between a master and slave digital print engines is determined.

FIG. 6 schematically depicts a flow chart showing how synchronization offset time between a master and slave digital print engines is chosen for different size papers.

### DETAILED DESCRIPTION OF THE INVENTION

In order to maximize productivity, different image frame sizes are utilized for different size receivers. Generally, the frame sizes are defined as preset portions of a primary imaging member in a printer such as equal portions that are from integral divisors of a primary imaging member (PIM), such as a photoreceptor, used in an electrophotographic engine. While this is often done to avoid a splice in a seemed PIM, it may be desirable for other reasons as well. For example, various process control algorithms may require that specific locations of a PIM be used solely for specific marks related to process control.

Many applications in printing, especially digital printing and more particularly electrophotographic printing require that multiple print engines be sequentially ganged together to maximize printing efficiency. For example, as described in U.S. patent application Ser. Nos. 12/126,192 and 12/126,267, an electrophotographic printer can comprise two similar print engines that have been coupled together. A module termed a productivity module inverts the receiver sheets between the coupled modules, thereby allowing the production of duplex images to be formed on a receiver at the full process speed of an individual module, effectively doubling productivity.

To maximize printing efficiency and speed, the smallest frame size possible is generally chosen for a given size receiver. As described in U.S. patent application Ser. Nos. 12/126,192 and 12/126,267, for coupled print engine configurations, the image frames for a slave print engine must be synchronized to those in the master print engine so that sheets are delivered from to the slave engine at the correct time for a specific image frame. As described in U.S. patent application Ser. No. 12/128,897, the image frames must also be delayed to allow for the time required for the receiver to travel from the image transfer location in one engine to the corresponding location in the second engine.

In some applications, as previously discussed, a digital print engine comprises two coupled printing modules separated by an inverter that flips the paper between the modules so that the second print engine forms a print on the reverse side of the receiver from that formed by the first print engine. For such applications, the inverter would have to transport the receiver at a high enough velocity to invert the longest receiver in the time normally allotted for inversion in the smallest image frame size mode if the same delay or temporal offset were used for all paper sizes. Because both the time to invert sheets and the time allotted for the corresponding image frames increase with receiver/image frame size, the optimum timing offset increases with image frame size. By intentionally defining different offsets for each frame mode, the inverter speed can be minimized without unduly compromising timing latitude. In other words, the timing latitude can be maximized for a given inverter speed.

The aforementioned patent applications disclose a method of synchronizing a slave print engine to a master by adjusting the appropriate print engine speed to achieve a consistent temporal offset between frame markers on the photoreceptors of the two print engines. According to these applications, the frame markers are physical markings such as perforations, splices, etc. If multiple frame modes are desired, it would be necessary to add additional markings for each frame of each mode. This is not desirable and, in some configurations such as when the PIM comprises a photoreceptive drum rather than a web, this is not even feasible. The timing marks can be marks printed on the PIM or transferred to a receiver. Alternatively, the marks can be generated signals controlled by a controller by sensing a location, such as a perforation, on the PIM. Thus these marks can be measured directly and be physical marks or be virtual marks that are actually electronic signals based on a location that can be determined using an encoder and the marks can be stored electronically in the engine control module.

In general, the timing offset of the first and second engines are determined by paper transport time from image transfer in the first engine to the image transfer in the second engine. If the sheet is inverted between the engines, the transport time can be a function of the receiver length. In order to obtain sufficient timing latitude to compensate for varying receiver sheet sizes, one could run the inverter assembly at a very high rate of speed to minimize the effects of receiver size. Alternatively, one can use the maximum size image frame for all receiver sizes. However, this would significantly reduce productivity.

The optimum timing offset that is described in this invention to allow synchronization is a function of the time required to transport the receiver from the image transfer location in the first print engine to that in the second print engine. As the timing offset can vary from printer to printer due to drive roller tolerances, the length or circumference of the photoreceptor, the paper path length, and engine to engine mating variations, it is necessary to provide a means to determine and set the required offset by a field engineer on the specific print engines. This is even more problematic when one is upgrading an existing single module print engine with a second print engine and, perhaps, even an inverter.

This invention describes a simple and direct method of achieving this synchronization using the optimum timing offset determined as described below. In this invention, the offset is set to a value corresponding to that for the smallest image frame size. Printing is initiated and the sheet arrival time is measured at a convenient point such as a registration or image transfer point. In order to minimize variability in this measurement, the sheets are directed in the non-invert path and the arrival time at the optical sensor in the Pre-Registration Assembly is measured relative to the slave engine image frame marker (F-Perf).

The average sheet arrival time for a number of sheets is compared to the target arrival time. The target arrival time is defined as the nominal arrival time, which is the arrival time that is expected to occur, of the lead edge of the receiver sheet at a specified location in a print engine such as the aforementioned optical sensor which is an actual sheet arrival time under normal operating conditions but may vary because of a number of variations such as feed slippage, the fuser make up, such as size, and writer conditions. Even small variations can have a large effect of the precise printing at high speeds that is exhibited by the NexPress 3000 and other higher speed high quality machines. A single arrival time is not accurate enough inmost of these conditions so it is substituted by an average the sheet arrival time that will be discussed below. The synchronization through the generated optimum timing offset is then adjusted accordingly so that the synchronization is optimized. By using the controller to calculate an average arrival time from actual sheet arrival times and an estimated location of one or more non-printable area in a particular set of conditions such as those discussed above and others that affect the printing quality and speed. This program should be run whenever timing is likely to have changed significantly such as upon installation replacement of parts or components, or when there has been significant wear. This can be signaled by a machine generated code indicating that the sheet arrival time is approaching the input latitude of the registration or likely to impinge upon a nonimagable portion of the PIM. Alternatively, this program can be run occasionally to reduce timing variability and prevent abrupt changes in timing

Because the vast majority of the timing variability that needs to be calibrated is common for all frame modes, this service program is only run for the most stringent frame mode and that correction is applied to all modes. In one embodiment of this invention that does not invert the sheets, it is suitable, not only for the case of coupled single color print engines separated by an inverter, but for other print engines such as color print engines whereby color prints corresponding to the separate colors comprising the finished print are produced on separate engines and registered either on an intermediate member or on the receiver.

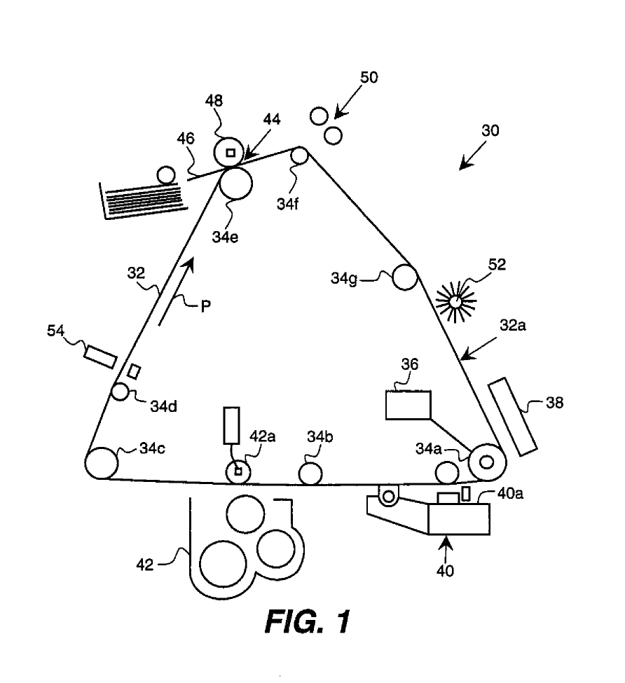

FIG. 1 schematically illustrates an embodiment of an electrophotographic print engine 30. The print engine 30 has a movable recording member such as a photoreceptive belt 32, which is entrained about a plurality of rollers or other supports 34a through 34g. The photoreceptive belt 32 may be more generally referred-to as a primary imaging member (PIM) 32. A primary imaging member (PIM) 32 may be any charge carrying substrate which may be selectively charged or discharged by a variety of methods including, but not limited to corona charging/discharging, gated corona charging/discharging, charge roller charging/discharging, ion writer charging, light discharging, heat discharging, and time discharging.

One or more of the rollers 34a-34g are driven by a motor 36 to advance the PIM 32. Motor 36 preferably advances the PIM 32 at a high speed, such as 20 inches per second or higher, in the direction indicated by arrow P, past a series of workstations of the print engine 30, although other operating speeds may be used, depending on the embodiment. In some embodiments, PIM 32 may be wrapped and secured about a single drum. In further embodiments, PIM 32 may be coated onto or integral with a drum.

It is useful to define a few terms that are used in relation to this invention. Optical density is the log of the ratio of the intensity of the input illumination to the transmitted, reflected, or scattered light, or D=log(Iᵢ/Iₒ) where D is the optical density, I_{I} is the intensity of the input illumination, Iₒ is the intensity of the output illumination, and log is the logarithm to the base 10. Thus, an optical density of 0.3 means that the output intensity is approximately half of the input intensity which is desirable for quality prints.

For some applications, it is preferable to measure the intensity of the light transmitted through a sample such as a printed image. This is referred to as the transmission density and is measured by first nulling out the density of the substrate supporting the image and then measuring the density of the chosen region of the image by illuminating the image through the back of the substrate with a known intensity of light and measuring the intensity of the light transmitted through the sample. The color of the light chosen corresponds to the color of the light principally absorbed by the sample. For example, if the sample consists of a printed black region, white light would be used. If the sample was printed using the subtractive primary colors (cyan, magenta, or yellow), red, green, or blue light, respectively, would be used.

Alternatively, it is sometimes preferable to measure the light reflected or scattered from a sample such as a printed image. This is referred to as the reflection density. This is accomplished by measuring the intensity of the light reflected from a sample such as a printed image after nulling out the reflection density of the support. The color of the light chosen corresponds to the color of the light principally absorbed by the sample. For example, if the sample consists of a printed black region, white light would be used. If the sample was printed using the subtractive primary colors (cyan, magenta, or yellow), cyan, magenta, or yellow light, respectively, would be used.

A suitable device for measuring optical density is an X-Rite densitometer with status A filters. Some such devices measure either transmission or reflected light. Other devices measure both transmission and/or reflection densities. Alternatively, for use within a printing engine, densitometers such as those described by Rushing in U.S. Pat. Nos. 6,567,171, 6,144,024, 6,222,176, 6,225,618, 6,229,972, 6,331,832, 6,671,052, and 6,791,485 are well suited. Other densitometers, as are known in the art, are also suitable.

The size of the sample area required for densitometry measurements varies, depending on a number of factors such as the size of the aperture of the densitometer and the information desired. For example, microdensitomers are used to measure site-to-site variations in density of an image on a very small scale to allow the granularity of an image to be measured by determining the standard deviation of the density of an area having a nominally uniform density. Alternatively, densitometers also are used having an aperture area of several square centimeters. These allow low frequency variations in density to be determined using a single measurement. This allows image mottle to be determined. For simple determinations of image density, the area to be measured generally has a radius of at least 1 mm but not more than 5 mm.

The term module means a device or subsystem designed to perform a specific task in producing a printed image. For example, a development module in an electrophotographic printer would include a primary imaging member (PIM) such as a photoreceptive member and one or more development stations that would image-wise deposit marking or toner particles onto an electrostatic latent image on the PIM, thereby rendering it into a visible image. A module can be an integral component in a print engine. For example, a development module is usually a component of a larger assembly that includes writing transfer and fuser modules such as are known in the art. Alternatively, a module can be self contained and can be made in a manner so that they are attached to other modules to produce a print engine. Examples of such modules include scanners, glossers, inverters that will invert a sheet of paper or other receiver to allow duplex printing, inserters that allow sheets such as covers or preprinted receivers to be inserted into documents being printed at specific locations within a stack of printed receiver sheets, and finishers that can fold, stable, glue, etc. the printed documents.

A print engine includes sufficient modules to produce prints. For example, a black and white electrophotographic print engine would generally include at least one development module, a writer module, and a fuser module. Scanner and finishing modules can also be included if called for by the intended applications.

A print engine assembly, also referred to in the literature as a reproduction apparatus, includes a plurality of print engines that have been integrally coupled together in a manner to allow them to print in a desired manner. For example, print engine assemblies that include two print engines and an inverter module that are coupled together to increase productivity by allowing the first print engine to print on one side of a receiver, the receiver then fed into the inverter module which inverts the receiver and feeds the receiver into the second print engine that prints on the inverse side of the receiver, thereby printing a duplex image.

A digital print engine is a print engine wherein the image is written using digital electronics. Such print engines allow the image to be manipulated, image by image, thereby allowing each image to be changed. In contrast, an offset press relies on the image being printed using press plates. Once the press plate is made, it cannot be changed. An example of a digital print engine is an electrophotographic print engine wherein the electrostatic latent image is formed on the PIM by exposing the PIM using a laser scanner or LED array. Conversely, an electrophotographic apparatus that relies on forming a latent image by using a flash exposure to copy an original document would not be considered a digital print engine.

A digital print engine assembly is a print engine assembly that a plurality of print engines of which at least one is a digital print engine.

Contrast is defined as the maximum value of the slope curve of the density versus log of the exposure. The contrast of two prints is considered to be equal if they differ by less than 0.2 ergs/cm² and preferably by less than 0.1 ergs/cm².

Print engine 30 may include a controller or logic and control unit (LCU) (not shown). The LCU may be a computer, microprocessor, application specific integrated circuit (ASIC), digital circuitry, analog circuitry, or a combination or plurality thereof. The controller (LCU) may be operated according to a stored program for actuating the workstations within print engine 30, effecting overall control of print engine 30 and its various subsystems. The LCU may also be programmed to provide closed-loop control of the print engine 30 in response to signals from various sensors and encoders. Aspects of process control are described in U.S. Pat. No. 6,121,986 incorporated herein by this reference.

A primary charging station 38 in print engine 30 sensitizes PIM 32 by applying a uniform electrostatic corona charge, from high-voltage charging wires at a predetermined primary voltage, to a surface 32a of PIM 32. The output of charging station 38 may be regulated by a programmable voltage controller (not shown), which may in turn be controlled by the LCU to adjust this primary voltage, for example by controlling the electrical potential of a grid and thus controlling movement of the corona charge. Other forms of chargers, including brush or roller chargers, may also be used.

An image writer, such as exposure station 40 in print engine 30, projects light from a writer 40a to PIM 32. This light selectively dissipates the electrostatic charge on photoreceptive PIM 32 to form a latent electrostatic image of the document to be copied or printed. Writer 40a is preferably constructed as an array of light emitting diodes (LEDs), or alternatively as another light source such as a Laser or spatial light modulator. Writer 40a exposes individual picture elements (pixels) of PIM 32 with light at a regulated intensity and exposure, in the manner described below. The exposing light discharges selected pixel locations of the photoreceptor, so that the pattern of localized voltages across the photoreceptor corresponds to the image to be printed. An image is a pattern of physical light, which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

After exposure, the portion of PIM 32 bearing the latent charge images travels to a development station 42. Development station 42 includes a magnetic brush in juxtaposition to the PIM 32. Magnetic brush development stations are well known in the art, and are desirable in many applications; alternatively, other known types of development stations or devices may be used. Plural development stations 42 may be provided for developing images in plural gray scales, colors, or from toners of different physical characteristics. Full process color electrographic printing is accomplished by utilizing this process for each of four toner colors (e.g., black, cyan, magenta, yellow).

Upon the imaged portion of PIM 32 reaching development station 42, the LCU selectively activates development station 42 to apply toner to PIM 32 by moving backup roller 42a and PIM 32, into engagement with or close proximity to the magnetic brush. Alternatively, the magnetic brush may be moved toward PIM 32 to selectively engage PIM 32. In either case, charged toner particles on the magnetic brush are selectively attracted to the latent image patterns present on PIM 32, developing those image patterns. As the exposed photoreceptor passes the developing station, toner is attracted to pixel locations of the photoreceptor and as a result, a pattern of toner corresponding to the image to be printed appears on the photoreceptor. As known in the art, conductor portions of development station 42, such as conductive applicator cylinders, are biased to act as electrodes. The electrodes are connected to a variable supply voltage, which is regulated by a programmable controller in response to the LCU, by way of which the development process is controlled.

Development station 42 may contain a two-component developer mix, which includes a dry mixture of toner and carrier particles. Typically the carrier preferably includes high coercivity (hard magnetic) ferrite particles. As a non-limiting example, the carrier particles may have a volume-weighted diameter of approximately 30μ. The dry toner particles are substantially smaller, on the order of 6μ to 15μ in volume-weighted diameter. Development station 42 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to PIM 32 to develop the electrostatic images thereon and the carrier material remains at development station 42. As toner is depleted from the development station due to the development of the electrostatic image, additional toner may be periodically introduced by a toner auger (not shown) into development station 42 to be mixed with the carrier particles to maintain a uniform amount of development mixture. This development mixture is controlled in accordance with various development control processes. Single component developer stations, as well as conventional liquid toner development stations, may also be used.

A transfer station 44 in printing machine 10 moves a receiver sheet 46 into engagement with the PIM 32, in registration with a developed image to transfer the developed image to receiver sheet 46. Receiver sheets 46 may be plain or coated paper, plastic, or another medium capable of being handled by the print engine 30. Typically, transfer station 44 includes a charging device for electrostatically biasing movement of the toner particles from PIM 32 to receiver sheet 46. In this example, the biasing device is roller 48, which engages the back of sheet 46 and which may be connected to a programmable voltage controller that operates in a constant current mode during transfer. Alternatively, an intermediate member may have the image transferred to it and the image may then be transferred to receiver sheet 46. After transfer of the toner image to receiver sheet 46, sheet 46 is detacked from PIM 32 and transported to fuser station 50 where the image is fixed onto sheet 46, typically by the application of heat and/or pressure. Alternatively, the image may be fixed to sheet 46 at the time of transfer.

A cleaning station 52, such as a brush, blade, or web is also located beyond transfer station 44, and removes residual toner from PIM 32. A pre-clean charger (not shown) may be located before or at cleaning station 52 to assist in this cleaning. After cleaning, this portion of PIM 32 is then ready for recharging and re-exposure. Of course, other portions of PIM 32 are simultaneously located at the various workstations of print engine 30, so that the printing process may be carried out in a substantially continuous manner.

A controller provides overall control of the apparatus and its various subsystems with the assistance of one or more sensors, which may be used to gather control process, input data. One example of a sensor is belt position sensor 54.

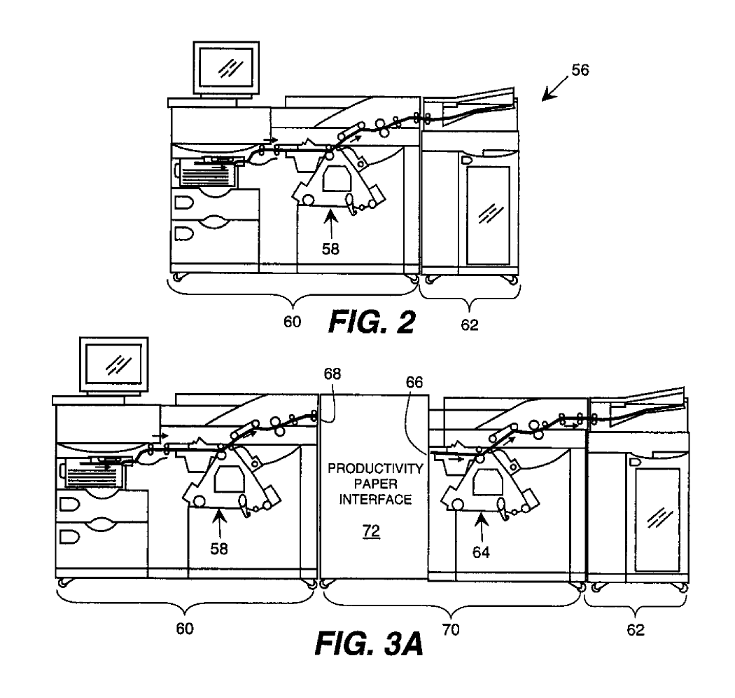

FIG. 2 schematically illustrates an embodiment of a reproduction apparatus 56 having a first print engine 58 that is capable of printing one or a multiple of colors. The embodied reproduction apparatus will have a particular throughput, which may be measured in pages per minute (ppm). As explained above, it would be desirable to be able to significantly increase the throughput of such a reproduction apparatus 56 without having to purchase an entire second reproduction apparatus. It would also be desirable to increase the throughput of reproduction apparatus 56 without having to scrap apparatus 56 and replacing it with an entire new machine.

Quite often, reproduction apparatus 56 is made up of modular components. For example, the print engine 58 is housed within a main cabinet 60 that is coupled to a finishing unit 62. For simplicity, only a single finishing device 62 is shown, however, it should be understood that multiple finishing devices providing a variety of finishing functionality are known to those skilled in the art and may be used in place of a single finishing device. Depending on its configuration, the finishing device 62 may provide stapling, hole punching, timing, cutting, slicing, stacking, paper insertion, collation, sorting, and binding.

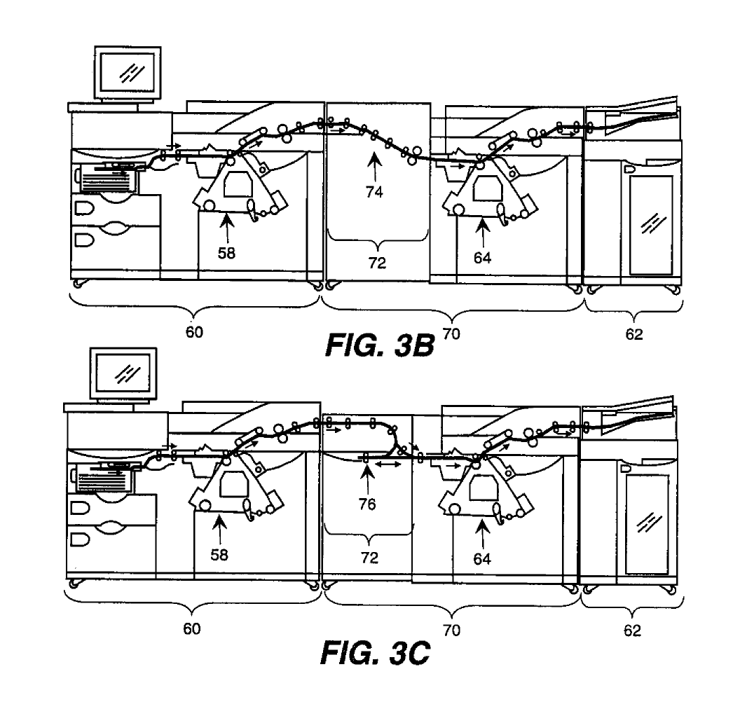

As FIG. 3A schematically illustrates, a second print engine 64 may be inserted in-line with the first print engine 58 and in-between the first print engine 58 and the finishing device 62 formerly coupled to the first print engine 58. The second print engine 64 may have an input paper path point 66 which does not align with the output paper path point 68 from the first print engine 58. Additionally, or optionally, it may be desirable to invert the receiver sheets from the first print engine 58 prior to running them through the second print engine (in the case of duplex prints). In such instances, the productivity module 70 which is inserted between the first print engine 58 and the at least one finisher 62 may have a productivity paper interface 72. Some embodiments of a productivity paper interface 72 may provide for matching 74 of differing output and input paper heights, as illustrated in the embodiment of FIG. 3B. Other embodiments of a productivity paper interface 72 may provide for inversion 76 of receiver sheets, as illustrated in the embodiment of FIG. 3C.

Providing users with the option to re-use their existing equipment by inserting a productivity module 70 between their first print engine 58 and their one or more finishing devices 62 can be economically attractive since the second print engine 64 of the productivity module 70 does not need to come equipped with the input paper handling drawers coupled to the first print engine 58. Furthermore, the second print engine 64 can be based on the existing technology of the first print engine 58 with control modifications which will be described in more detail below to facilitate synchronization between the first and second print engines.

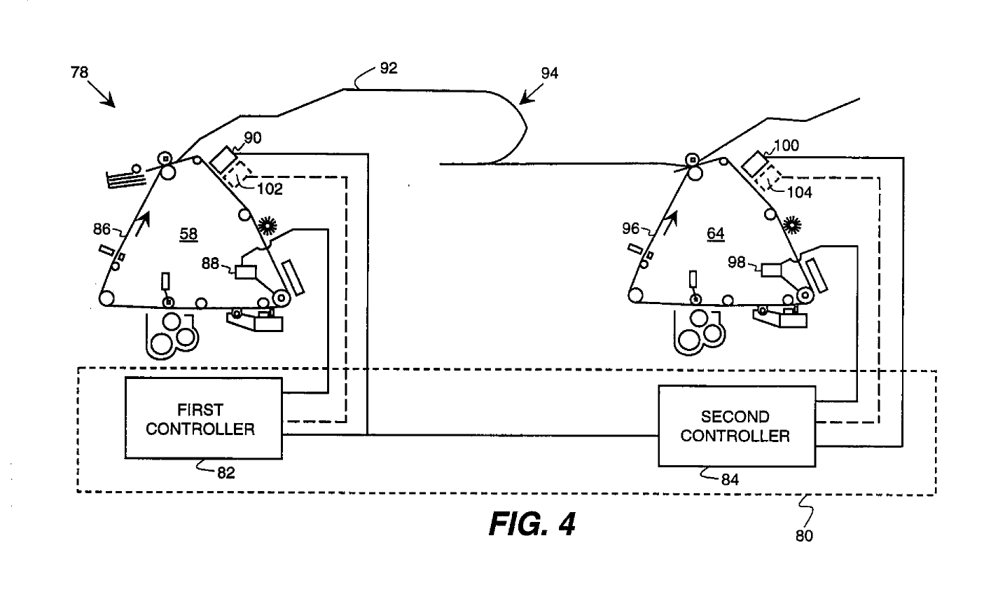

FIG. 4 schematically illustrates an embodiment of a reproduction apparatus 78 having embodiments of first and second print engines 58, 64 which are synchronized by a controller 80. Controller 80 may be a computer, a microprocessor, an application specific integrated circuit, digital circuitry, analog circuitry, or any combination and/or plurality thereof. In this embodiment, the controller 80 includes a first controller 82 and a second controller 84. Optionally, in other embodiments, the controller 80 could be a single controller as indicated by the dashed line for controller 80. The first print engine 58 has a first primary imaging member (PIM) 86, the features of which have been discussed above with regard to the PIM of FIG. 1. The first PIM 86 also preferably has a plurality of frame markers corresponding to a plurality of frames on the PIM 86. In some embodiments, the frame markers may be holes or perforations in the PIM 86 which an optical sensor can detect.

In other embodiments, the frame markers may be reflective or diffuse areas on the PIM, which an optical sensor can detect. Other types of frame markers will be apparent to those skilled in the art and are intended to be included within the scope of this specification. The first print engine 58 also has a first motor 88 coupled to the first PIM 86 for moving the first PIM when enabled. As used here, the term “enabled” refers to embodiments where the first motor 88 may be dialed in to one or more desired speeds as opposed to just an on/off operation. Other embodiments, however, may selectively enable the first motor 88 in an on/off fashion or in a pulse-width-modulation fashion.

The first controller 82 is coupled to the first motor 88 and is configured to selectively enable the first motor 88 (for example, by setting the motor for a desired speed, by turning the motor on, and/or by pulse-width-modulating an input to the motor). A first frame sensor 90 is also coupled to the first controller 82 and configured to provide a first frame signal, based on the first PIM's plurality of frame markers, to the first controller 82.

A second print engine 64 is coupled to the first print engine 58, in this embodiment, by a paper path 92 having an inverter 94. The second print engine 64 has a second primary imaging member (PIM) 96, the features of which have been discussed above with regard to the PIM of FIG. 1. The second PIM 96 also preferably has a plurality of frame markers corresponding to a plurality of frames on the PIM 96. In some embodiments, the frame markers may be holes or perforations in the PIM 96, which an optical sensor can detect. In other embodiments, the frame markers may be reflective or diffuse areas on the PIM which an optical sensor can detect. Other types of frame markers will be apparent to those skilled in the art and are intended to be included within the scope of this specification. The second print engine 64 also has a second motor 98 coupled to the second PIM 96 for moving the second PIM 96 when enabled. As used here, the term “enabled” refers to embodiments where the second motor 98 may be dialed in to one or more desired speeds as opposed to just an on/off operation. Other embodiments, however, may selectively enable the second motor 98 in a pulse-width-modulation fashion.

The second controller 84 is coupled to the second motor 98 and is configured to selectively enable the second motor 98 (for example, by setting the motor for a desired speed, or by pulse-width-modulating an input to the motor). A second frame sensor 100 is also coupled to the second controller 84 and configured to provide a second frame signal, based on the second PIM's plurality of frame markers, to the second controller 84. The second controller 84 is also coupled to the first frame sensor 90 either directly as illustrated or indirectly via the first controller 82 which may be configured to pass data from the first frame sensor 90 to the second controller 84.

While the operation of each individual print engine 58 and 64 has been described on its own, the second controller 84 is also configured to synchronize the first and second print engines 58, 64 on a frame-by-frame basis. Optionally, the second controller 84 may also be configured to synchronize a first PIM splice seam, also known as simply a seam or a splice, from the first PIM 86 with a second PIM splice seam from the second PIM 96. In the embodiments that synchronize the PIM splice seams, the first print engine 58 may have a first splice sensor 102 and the second print engine 64 may have a second splice sensor 104. In other embodiments, the frame sensors 90, 100 may be configured to double as splice sensors. This method can be applied to other problem areas besides seams, such as non-printable areas that the image would not print on well or at all. Another example of a black and white area is one that has a defect or flaw or even a cutout or hole punch. Other examples include preprinted areas and different surfaces, such as a plastic overlay. A black and white area could even be an area that a customer wanted left blank for some other reason and could be printed if desired.

In one embodiment the synchronization method_relies on timing the slave engine to the master engine using optimum offset timings. The master engine and the slave engine are referred to elsewhere alternately as the first engine and the second engine for simplicity. Note that the master engine could be either the first or second engine or any one of a series of engines as long as there is a master and the slave engine(s) timing is set by the timing of the master engine. The master can be the second engine, so one could, in principle, time the first engine off the second, which would be the master. Also, the digital print assembly, in some embodiments includes more than two print engines. For example, suppose we couple 2 NexPress 3000s with an inverter between the engines. That is why I used the term “plurality”. Also, please note that the slave for one pair of print engines can become the master for a new set. Example: Suppose there are 3 print engines and engine 1 is the master for timing engine 2. Once the paper is in engine 2, engine 2 can become the master for timing engine 3. This sliding master scenario has the advantage of minimizing the propagation of timing errors.

Locating the seams on the two PIMs can be done, but it then requires that the engine be timed very accurately. This is problematical and does not allow for engine speed variations when one switches from one type or weight of receiver to another. Moreover, the seam may not be very sharp. In fact, they are often overcoated with an adhesive to minimize the offset between the two mating surfaces. This would preclude precise determination of the position with a sensor so that the use of a seam position relative to a fixed position is preferred as described in this present synchronization method.

The efficiency and accuracy of synchronizing the engines is function of the number of timing samples measured in a given period. The efficiency and accuracy are improved with an increasing number of timing samples. As there typically are between four and six frame markers on a PIM, the engines can be synchronized much faster Man relying solely on locating a single fiducial on the PIM such as a seam. In addition, the adjustments to the speed of the slave engine is more accurate and the changes to the speed converge more rapidly to the desired synchronization.

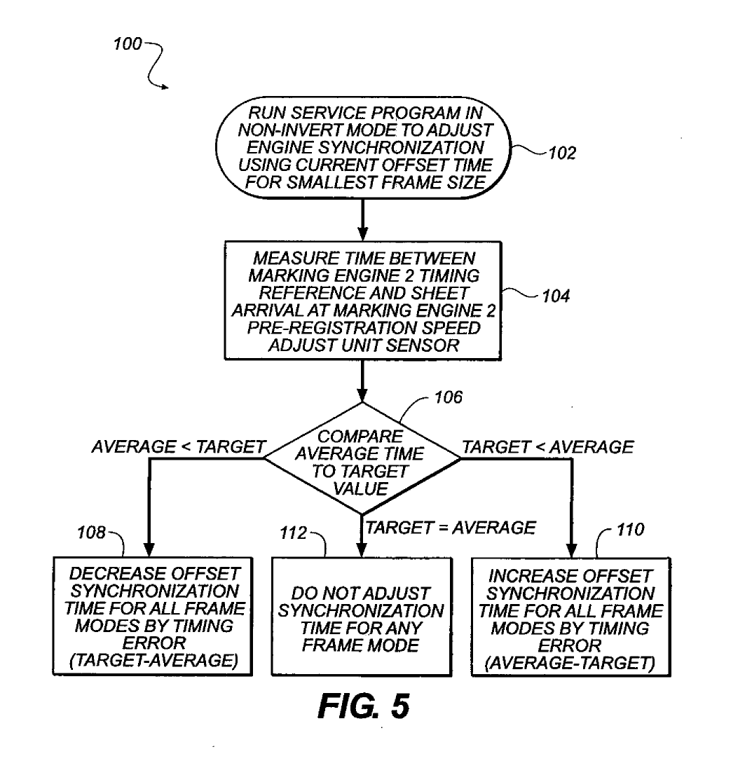

FIG. 5 shows a schematic of how the present invention operates in a preferred mode of operation comprising two print engines, such as two black and white engines, coupled to each other through an inverter. This flowchart 100 shows how the synchronization timing offset time between a first master and a second slave digital print engines is determined in one embodiment. A service program is run in non-invert mode to adjust the timing offset using the current offset time for the smallest frame size anticipated to be printed.102, the time between the marking engine 2 at a reference or fixed location and the sheet arrival at marking engine 2 at the pre-registration speed adjust sensor 104 is measured and the average time that is calculated as described above, is compared to the target time 106. If the average time is less than the target time the timing offset for all frame modes is decreased by a timing error calculated as described above 108 but if the average time is greater than the target time the timing offset for all frame modes is increased by a timing error calculated as described below 110. Finally if the average time coincides or is substantially equal to the target time no adjustment is made to the timing offset. 112

While this discussion focuses on this preferred mode of operation, it is clear that it equally applies to other applications that may or may not comprise an inverter. For example, the present invention equally well applies to a print engine comprising a plurality of engines such as a color engine whereby full color prints are produced by separately printing on separate engines those colors comprising the subtractive primary colors cyan, magenta, yellow, and black. The present invention also applies to a series of coupled print engines comprising a plurality of print engines, each of which prints a different color on one side of a receiver, inverts the receiver, and an additional plurality of printers prints an image on the second side of the receiver. This is critical to do over longer time to prevent abrupt changes.

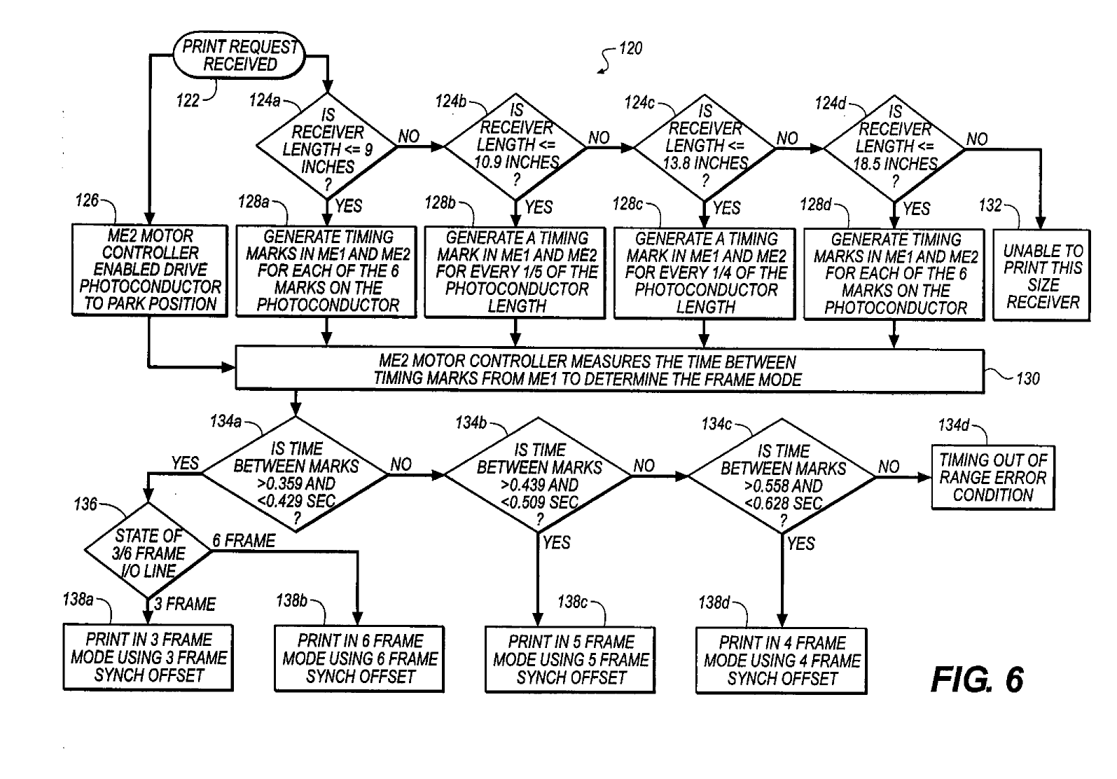

In order to maximize productivity, different image frame sizes are utilized for different size receivers. Generally, the frame sizes are defined as preset portions of a primary imaging member in a printer such as equal portions that are from integral divisors of a primary imaging member (PIM), such as a photoreceptor, used in an electrophotographic engine. While this is often done to avoid a splice in a seemed PIM, it may be desirable for other reasons as well. For example, various process control algorithms may require that specific locations of a PIM be used solely for specific marks related to process control, as shown in FIG. 6.

FIG. 6 is a flow chart of a preferred embodiment depicting how the timing offset time between a master and slave digital print engines is chosen for different size papers 120. When a print request is received 122, the size is determined in increments 124a-d while the controller puts the photoconductor in a parked position while appropriate timing marks are put on the photoconductor 128a-d that indicate the receiver size and or other receiver characteristics, such as paper type. Then the controller measures the time between the marks to determine an appropriate frame mode 130. If the printer cannot print this size paper the default will indicate so and not print unless over ruled. 132. The appropriate timing for the printer and receiver is set 134a-c or an indication that it is out of range is made 134d and adjustments as needed to speed or size made. Optionally a frame size state is then determined 136 and the receiver printed 138a-d as required.

In one preferred mode of practicing this invention, the service program that runs the coupled print engines is run in a non-invert mode using preset or default engine timing for the smallest frame size. The time between the marking engine sheet arrival time (timing reference) in the slave engine, also referred to as marking engine (engine 2) and the sheet arrival time at a fixed location, such as a pre-registration speed adjustment sensor, is measured. As variations in this time can occur, it is often desirable to obtain an average sheet arrival time rather than using a single sheet arrival time. The average sheet arrival time is calculated by averaging the sheet arrival times of at least two sheets, preferably twice the number of frames included in one revolution of the PIM, and more preferably at least twenty-five sheets. Although the average sheet arrival time does not require that the arrival time of sequential sheets be measured, it is preferable that at least the majority of the sheets be printed on separate frames so that errors in the sheet arrival times associated with specific frames are averaged out. By averaging a number of sheets, high frequency variations are averaged and the measurement precision can be decreased while maintaining the timing accuracy. However, it is not necessary to average more than 50 sheets as relatively little improvement in the accuracy would be obtained. It is not necessary to average the sheet arrival times of more than 50 sheets as little additional accuracy would be gained.

The average sheet arrival time is compared to the target arrival time. If the two arrival times coincide, no adjustment of the optimum time offset, also sometimes referred to in certain circumstances an optimum time delay, for any frame mode is made. If the average sheet arrival time is less than the target time, the timing offset is decreased by a target-average timing error which is the difference between the actual sheet arrival time and the nominal sheet arrival time. Conversely, if the target time is less than the average sheet arrival time, the optimum time delay is increased for all frame modes by a single or an average target timing error. This is accomplished by determining the position of timing marks on the primary imaging member of the first print engine, directing a receiving sheet from the first print engine to the second print engine, determining the arrival time of the receiving sheet in the second print engine, and synchronizing by adjusting the time delay of the second print engine using the timing of the second engine using the timing marks on the first engine and the actual arrival time, or the average arrival time, of the sheet from the first to the second engine. It should be noted that the timing marks can correspond to permanent marks such as a splice or perforation in the photoreceptor. Alternatively, the marks can be produced within the master and slave engines. Examples include marks that are developed onto the photoreceptors of each engine using a test target.

Although this disclosure has, thus far, discussed the use of this invention in avoiding seams, it is apparent that there may be other nonprintable areas on one or more PIMs. For example, assume that the electrostatic latent image is deposited in areas that have been photo-discharged on a photoreceptive PIM. This is the most common mode of practice when printing using an electrophotographic digital print engine. A small puncture in the photoconductive layer of the PIM that protrudes to the grounded layer, as might occur if a carrier particle is deposited on and not scavenged from the PIM, would result in an area being fully discharged irrespective of illumination. This would result in a significant amount of toner being deposited on and around the defect and would result in what is often referred to as a “black spot” on the final print. If a black spot is noted, the user can adjust the printer timing to avoid that particular region of a frame or, if necessary, the entire frame by introducing an appropriate delay in the formation of the electrostatic latent image. This would require, then, that the receiver timing be adjusted. If the defect is in the PIM of the master engine, only the master timing need be adjusted, as the timing of the slave engine would follow. If the defect or other nonprintable area were to occur on the slave engine, the location of the defect would have to be inputted into the control module for the master engine and the timing of the printing or the determination to skip the particular frame in total, would then be made. The timing of the slave engine would then be adjusted accordingly, as practiced by this invention.

In another embodiment of this invention, this invention comprises method of synchronizing the timing of a plurality of physically coupled print engines wherein the receiving sheet is inverted between a first and a second print engine including determining a position of one or more timing marks on a first primary imaging member in a first print engine having a first dining, directing a receiving sheet from the first print engine to a second primary imaging member in a second print engine having a second timing, determining an actual arrival time of the receiving sheet relative to a fixed position in the second print engine, and calculating an optimum timing offset using the one or more timing marks on the first primary imaging member, the actual arrival time of the receiving sheet and the distance of the non-printable area to the fixed position in the second engine.

In one preferred mode of practicing this invention, the timing marks on the primary imaging member of the first print engine are made by the first print engine. While the term master and first print engine are often used interchangeable, as are the terms slave and second print engine, it is clear from the use of the terms that any engine within the series of coupled print engines can serve as the master and any others can serve as slaves. Moreover, a specific print engine can be a slave to one print engine, but the master to another.

This invention is particularly suited for upgrading a single print engine in the field with multiple print engines with or without an inverter. This invention is also particularly suited for synchronizing print engines for use with receivers having a variety of sizes.

The invention has been described in detail with particular reference to certain preferred embodiments thereof, but it will be understood that variations and modifications can be effected within the spirit and scope of the invention.

What is claimed is:

1. A method of synchronizing the timing of a plurality of physically coupled print engines comprising:
determining a position of one or more timing marks on a first primary imaging member in a first print engine having a first timing;
directing a receiving sheet from the first print engine to a second primary imaging member in a second print engine having a second timing;
determining an nominal arrival time of the receiving sheet relative to a fixed position in the second print engine; and
calculating an optimum timing offset using the one or more timing marks on the first primary imaging member, the nominal arrival time of the receiving sheet and the distance of a non-printable area to the fixed position in the second engine.

2. The method of claim 1 wherein the calculating an optimum timing offset further comprises calculating the nominal arrival time using an average sheet arrival time by comparing the average sheet arrival time to a target offset time and
if they do not coincide then one of the following two actions are taken: if the average sheet arrival time is less than the offset time, the optimum offset time is decreased by an target-average timing error representing a difference between an actual sheet arrival time and the nominal sheet arrival time and if the offset time is less than the average sheet arrival time, the optimum offset time is increased for all frame modes by the target-average timing error.

3. The method of claim 1 wherein the optimum time offset is calculated by a controller on one of the first engine and the second engine.

4. The method of claim 1 wherein the fixed position is calculated relative to a seam location for one or more seams located by one of a seam sensor and a frame sensor.

5. The method of claim 1 wherein the non-printable area comprises one or more seams on the primary imaging member.

6. The method according to claim 1 whereby the timing marks on the primary imaging member of the first print engine are made by the first print engine.

7. The method according to claim 1 whereby the optimum time offset can be adjusted to accommodate receivers of differing sizes.

8. The method according to claim 1 further comprising determining the position of timing marks on the primary imaging member of the first print engine, directing a receiving sheet from the first print engine to the second print engine, determining the average offset timing based on the sheet arrival time in the second print engine, and adjusting the timing of the second engine using the timing marks on the first engine and the actual arrival time of the sheet from the first to the second engine wherein the timing marks correspond to permanent marks in the photoreceptor.

9. The method according to claim 1 wherein the marks are produced virtually.

10. A method of synchronizing the timing of a plurality of physically coupled print engines comprising:
determining a position of one or more timing marks from a first primary imaging member in a first print engine having a first timing;
directing a receiving sheet from the first print engine to a second primary imaging member in a second print engine having a second timing;
determining an actual arrival time of the receiving sheet relative to a fixed position in the second print engine and storing it in a controller;
using the controller to calculate an average arrival time from the actual sheet arrival times and an estimated location of one or more non-printable areas under a particular set of conditions; and
calculating an optimum timing offset using the one or more timing marks, the average arrival time of the receiving sheet and the estimated location of the non-printable area.

11. The method of claim 10 wherein the calculating an optimum timing offset further comprises calculating the average sheet arrival time by comparing the average sheet arrival time to a target offset time and if they do not coincide then one of the following two actions are taken: if the average sheet arrival time is less than the offset time, the optimum offset time is decreased by an target-average timing error representing a difference between an actual sheet arrival time and the nominal sheet arrival time and if the offset time is less than the average sheet arrival time, the optimum offset time is increased for all frame modes by the target-average timing error.

12. The method of claim 10 wherein the fixed position is calculated relative to a seam location for one or more seams located by one of a seam sensor and a frame sensor.

13. The method of claim 10 wherein the non-printable area comprises one or more seams on the primary imaging member.

14. The method according to claim 10 whereby the timing marks on the primary imaging member of the first print engine are made by the first print engine.

15. The method according to claim 10 whereby the optimum time offset can be adjusted to accommodate receivers of differing sizes.

16. The method according to claim 10 further comprising determining the position of timing marks on the primary imaging member of the first print engine, directing a receiving sheet from the first print engine to the second print engine, determining the average offset timing based on the sheet arrival time in the second print engine, and adjusting the timing of the second engine using the timing marks on the first engine and the actual arrival time of the sheet from the first to the second engine wherein the timing marks correspond to permanent marks in the photoreceptor.

17. The method according to claim 10 wherein the marks are produced virtually.

18. The method of claim 10 wherein the average sheet arrival time is calculated by averaging the sheet arrival times of at least twenty-five sheets.

19. The method of claim 10 wherein the average sheet arrival time is calculated by averaging the sheet arrival times of at least two times the number of frames on the PIM.

20 A method of synchronizing the timing of a plurality of physically coupled print engines comprising:
determining a position of one or more timing marks from a first primary imaging member in a first print engine having a first timing;
directing a receiving sheet from the first print engine to a second primary imaging member in a second print engine having a second timing;
determining an actual arrival time of the receiving sheet at a pre-registration speed adjustment sensor relative to a fixed position in the second print engine and storing it in a controller; and
using the controller to calculate an average arrival time from the actual sheet arrival time and an estimated location of one or more non-printable areas under a particular set of conditions; and
calculating an optimum timing offset using the one or more timing marks, the average arrival time of the receiving sheet and the estimated location of the non-printable area such that the calculated average sheet arrival time is the averaged sheet arrival times of at least twice a number of frames included in one revolution of the primary imaging member and the average sheet arrival time is compared so that if they do not coincide then one of the following two actions are taken: if the average sheet arrival time is less than the offset time, the optimum offset time is decreased by an target-average timing error representing a difference between an actual sheet arrival time and the nominal sheet arrival time and if the offset time is less than the average sheet arrival time, the optimum offset time is increased for all frame modes by the target-average timing error
